(19) United States
(12) Patent Application Publication
(10) Pub. No.: US 2025/0215282 A1
(43) Pub. Date: Jul. 3, 2025

(54) THERMALLY CURABLE HOT-MELT PRESSURE SENSITIVE ADHESIVE

(71) Applicant: BASF SE, Ludwigshafen am Rhein (DE)

(72) Inventors: Singa D. TOBING, Charlotte, NC (US); Joel BASILAN, Fort Mill, SC (US); Timothy KLOTS, Trenton, NJ (US); Philip S. WILLIAMS, Charlotte, NC (US); Hiruy YIGEZU, Fort Mill, SC (US); Sujith CHACKO, Charlotte, NC (US)

(73) Assignee: BASF SE, Ludwigshafen am Rhein (DE)

(21) Appl. No.: 19/022,244

(22) Filed: Jan. 15, 2025

Related U.S. Application Data
(63) Continuation-in-part of application No. 18/531,246, filed on Dec. 6, 2023.
Application No. 18/531,246 is a continuation-in-part of application No. PCT/US2022/032542, filed on Jun. 7, 2022.
(60) Provisional application No. 63/197,862, filed on Jun. 7, 2021.

(51) Int. Cl. C09J 7/38; B32B 5/02; B32B 7/12; B32B 25/08; B32B 25/14; B32B 27/36; C09J 5/06; C09J 11/08

(52) U.S. Cl. CPC C09J 7/385; B32B 5/022; B32B 5/024; B32B 7/12; B32B 25/08; B32B 25/14; B32B 27/36; C09J 5/06; C09J 11/08; B32B 2255/10; B32B 2255/26; B32B 2262/0253; B32B 2262/0276; B32B 2262/0284; B32B 2307/7376; B32B 2307/748; B32B 2419/06; C09J 2203/346; C09J 2301/302; C09J 2301/304; C09J 2301/408; C09J 2301/414

(57) ABSTRACT

A multilayer composite containing a polymeric membrane, a hot-melt adhesive layer, and a release liner, wherein the hot-melt adhesive layer comprises a thermally curable pressure-sensitive adhesive and tackifier. The invention further relates to a process to make the composite and to use the composite as a roofing material, label, tape, Graphics and Medical applications.

### CROSS-REFERENCE TO RELATED APPLICATIONS

This application is a continuation-in-part of U.S. Non-Provisional application Ser. No. 18/531,246, filed Dec. 6, 2023, which is a continuation-in-part of International Application No. PCT/US2022/032542, filed Jun. 7, 2022, which claims benefit of U.S. Application No. 63/197,862, filed Jun. 7, 2021, all of which are incorporated herein by reference in their entirety.

### FIELD OF THE INVENTION

This invention pertains to a thermally curable hot-melt pressure sensitive adhesive composition, a multilayer composite comprising a substrate, an adhesive layer comprising the thermally curable hot-melt pressure sensitive adhesive composition and a release member, wherein the adhesive layer is a pressure-sensitive adhesive that is at least partially cured, and method of making the multilayer composite.

### BACKGROUND OF THE INVENTION

Multilayer composites, also referred to as multilayer membrane, peel-and-stick membranes or panels, are used in the construction industry to cover flat or low-sloped roofs. These membranes provide protection to the roof from the environment, particularly in the form of a waterproof barrier. As is known in the art, commercially available membranes include thermoset membranes such as those including cured EPDM (i.e., ethylene-propylene-diene terpolymer rubber) or thermoplastics such as TPO (i.e., thermoplastic olefins), PVC (i.e., polyvinylchloride) and modified bitumen.

These membranes are typically delivered to a construction site in a bundled roll, transferred to the roof, and then unrolled and positioned. The sheets are then affixed to the building structure by employing varying techniques such as mechanical fastening, ballasting, and/or adhesively adhering the membrane to the roof. The roof substrate to which the membrane is secured may be one of a variety of materials depending on the installation site and structural concerns. For example, the surface may be a concrete, metal, gypsum, plywood, or wood deck, it may include insulation or recover board, and/or it may include an existing membrane.

In addition to securing the membrane to the roof—which mode of attachment primarily seeks to prevent wind uplift—the individual membrane panels, together with flashing and other accessories, are positioned and adjoined to achieve a waterproof barrier on the roof. Typically, the edges of adjoining panels are overlapped, and these overlapping portions are adjoined to one another through a number of methods depending upon the membrane materials and exterior conditions. One approach involves providing adhesives or adhesive tapes between the overlapping portions, thereby creating a water resistant seal. Alternatively, if the membranes are thermoplastics, they may be heat sealed.

With respect to the former mode of attachment, which involves securing the membrane to the roof, the use of adhesives allows for the formation of a fully adhered roofing system. In other words, a majority, if not all, of the membrane panel is secured to the roof substrate, as opposed to mechanical attachment methods that can only achieve direct attachment in those locations where a mechanical fastener affixes the membrane.

When adhesively securing a membrane to a roof, such as in the formation of a fully adhered system, there are a few common methods employed. The first is known as contact bonding whereby technicians coat both the membrane and the substrate with an adhesive, and then mate the membrane to the substrate while the adhesive is only partially set.

Another mode of attachment is through the use of a pre-applied adhesive to the bottom surface of the membrane. In other words, prior to delivery of the membrane to the job site, an adhesive is applied to the bottom surface of the membrane. In order to allow the membrane to be rolled and shipped, a release film or member is applied to the surface of the adhesive. During installation of the membrane, the release member is removed, thereby exposing the pressure-sensitive adhesive, and the membrane can then be secured to the roofing surface without the need for the application of additional adhesives.

As is known in the art, the pre-applied adhesive can be applied to the surface of the membrane in the form of a hot-melt adhesive. For example, U.S. Publication No. 2004/0191508, which teaches peel and stick thermoplastic membranes, employs pressure-sensitive adhesive compositions comprising styrene-ethylene-butylene-styrene (SEBS), tackifying endblock resins such as cumarone-indene resin and tackifying midblock resins such as terpene resins. This publication also suggests other hot-melt adhesives such as butyl-based adhesives, EPDM-based adhesives, acrylic adhesives, styrene-butadiene adhesives, polyisobutylene adhesives, and ethylene vinyl acetate adhesives.

These prior applications, however, have inherent limitations. For example, there are temperature windows that limit the minimum temperature at which peel-and-stick membranes can be installed on a roof surface. Additionally, there are maximum temperature limits on the roof surface that the adhesive can withstand while maintaining wind-uplift integrity. With respect to the latter, where the surface temperature on the roof nears the glass transition temperature of the adhesive, the adhesive strength offered by the pressure-sensitive adhesive is not maintained. Further, the large difference in thermal expansion-contraction coefficient and elasticity between the adhesive layer and the membrane can create tunneling or puckering when the laminate is installed at higher temperature on a roofing deck and naturally cooled down to ambient temperatures at nighttime. Similarly, tunneling or puckering may arise upon rising temperature, when membrane and roof deck are adhered to one another at below freezing temperatures.

While UV-curing of pressure sensitive adhesives is known, inherent limitations as to how much radiation energy maybe supplied to a given adhesive layer exists. The greater the thickness of the layer, the greater the energy need. However, it is further known that extensive radiation leads to non-uniformities in the layer.

As a result, peel-and-stick membranes have not gained wide acceptance in the industry. Moreover, the use of peel-and-stick membranes has been limited to use in conjunction with white membranes (e.g., white thermoplastic membranes) because the surface temperature of these membranes remains cooler when exposed to solar energy.

It is also known that known in the art of solvent based acrylic pressure sensitive adhesive compositions, such as those applied as solar films for example, are very slow to react, generally requiring cycle times of 5-8 hours and with essentially no reaction between any cross-linker and acid functionality, resulting in solutions that remain smooth and coatable. Rather, during long service time as a solar film, the cross linker and acid functionality in the acrylic pressure sensitive adhesive composition reacts slowly to offset the creep flow accelerated by the higher environmental temperature, so the adhered film remain clear, not hazy due to distortion. The very long curing time limits the applicability of these systems as an alternative to UV curable pressure sensitive adhesives.

Accordingly, there is a need for thermal curable hot-melt pressure sensitive adhesives, for peel-and-stick membrane or multilayer composite which are not sensitive to the above identified limitation, are suitable for any time installation, and are curable by methods other than UV to avoid non-uniformities within the adhesive layer. There is further a need for thermally curable hot-melt adhesives in applications such as films, labels and medical applications. More specifically, there is a need for thermally curable hot-melt pressure sensitive adhesives which cure rapidly, avoid premature gelation, and are capable of crosslinking when exposed to high temperature.

### BRIEF SUMMARY OF THE INVENTION

It was an object of the invention to develop a thermally curable hot-melt pressure sensitive adhesive, a multilayer composite comprising a polymeric membrane, an adhesive layer, wherein the adhesive layer is a thermally cured adhesive layer, and a release member, wherein the adhesive layer is a pressure-sensitive adhesive that is at least partially cured.

The following are embodiments of the invention:

Embodiment 1. A composition comprising:
an acrylic copolymer based on a polymerization of a monomer A, a monomer B, and a monomer C in an amount from 90% to 99.5% by weight,
and a crosslinker in an amount of from 0.5 wt. % to 10 wt. %, based on the total weight of the composition, based on total weight of the composition.

In an Embodiment 1a, the composition of Embodiment 1 comprises a tackifier. The tackifier comprises a natural resin or an ester of hydrogenated gum rosin. The natural resin comprises a rosin, a rosin derivative, polyterpene resins, terpene-phenolic resins, alkylphenol resins, and aliphatic, aromatic and aliphatic-aromatic hydrocarbon resins, and combinations thereof.

Embodiment 2. The composition of Embodiment 1, wherein monomer A is selected from the group consisting of methyl, ethyl, propyl, isoamyl, isooctyl, n-butyl, isobutyl, tert-butyl, cyclohexyl, 2-ethylhexyl, decyl, lauryl or stearyl acrylate and/or methacrylate, and mixtures thereof.

Embodiment 3. The composition of Embodiment 1 or Embodiment 2, wherein monomer B is selected from the group consisting of acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and-methacrylamide, N-methylolacrylamide and -methacrylamide, maleic acid monoamide and diamide, itaconic acid monoamide and diamide, fumaric acid monoamide and diamide, vinylsulfonic acid or vinylphosphonic acid, and mixtures thereof.

Embodiment 4. The composition of any of Embodiment 1 to 3, wherein monomer C is selected methyl acrylate, methyl methacrylate, ethyl methacrylate, n-butyl methacrylate, tert-butyl methacrylate, tert-butyl acrylate, isobutyl methacrylate, vinyl acetate, hydroxyethyl acrylate, hydroxyethyl methacrylate, cyclohexyl acrylate, cyclohexyl methacrylate, 2-ethoxyethyl methacrylate, 2-phenoxyethyl methacrylate, benzyl acrylate, benzyl methacrylate, hydroxypropyl methacrylate, styrene, 4-acetostyrene, acrylamide, acrylonitrile, 4-bromostyrene, n-tert-butylacrylamide, 4-tert-butylstyrene, 2,4-dimethylstyrene, 2,5-dimethylstyrene, 3,5-dimethylstyrene, isobornyl acrylate, isobornyl methacrylate, 4-methoxystyrene, methylstyrene, alpha methylstyrene, 4-methylstyrene, 3-methylstyrene, 2,4,6-trimethylstyrene, vinyl pyrrolidone, ureido methacrylate, and combinations thereof

Embodiment 5. The composition of any of Embodiment 1 to 4, wherein monomer A is selected from the group consisting of 2-ethylhexyl acrylate, butyl acrylate, and isooctyl acrylate, in an amount of from 50% by weight to 99.99% by weight based on the weight of the monomers A, B and C in the copolymer.

Embodiment 6. The composition of any of Embodiment 1 to 5, wherein monomer B is selected from the group consisting of acrylic acid, methacrylic acid, and itaconic acid, in an amount of from 0.1% by weight to 10% by weight based on the weight of the monomers A, B and C in the copolymer.

Embodiment 7. The composition of any of Embodiment 1 to 6, wherein monomer C is selected from the group consisting of methyl acrylate, methyl methacrylate, vinyl pyrrolidone, ureido methacrylate, styrene, and alpha methylstyrene in an amount of from 0.1% by weight to 25% by weight based on the weight of the monomers A, B and C in the copolymer.

Embodiment 8. The composition of any of Embodiment 1 to 7, wherein the crosslinker comprises an acrylate, a polyfunctional acrylate, a metal salt, a silane coupling agents, a polyfunctional isocyanate, a polyfunctional amine, or polyfunctional alcohol.

Embodiment 9. The composition of any of Embodiment 1 to 8, wherein the crosslinker comprises a glycidyl copolymer.

Embodiment 10. The composition of any of Embodiment 1 to 9, wherein the crosslinker has a glass transition temperature Tg of from about 0 to about −60° C., a weight average molecular weight of from 2 to 40,000 Da, a viscosity from about 1 to about 10,000 P at 25° C., and a functionality per chain of greater than 1 to about 10.

Embodiment 11. The composition of any of Embodiment 1 to 10, wherein the composition does not include a solvent.

Embodiment 12. A multilayer composite comprising:
a substrate;
a layer comprising the composition of any of Embodiment 1 to 11; and optionally,
a release liner.

Embodiment 13. The multilayer composite of Embodiment 12, wherein the layer comprising the composition is present in a thickness of from 5 μm to 500 μm.

Embodiment 14. The multilayer composite of Embodiment 12, wherein the layer comprising the composition is present in a thickness of 5 micron to 150 microns

Embodiment 15. The multilayer composite of Embodiment 12 or 13, wherein the layer comprising the composition is in contact with substantially all of one planar surface of the polymeric membrane.

Embodiment 16. The multilayer composite of any of Embodiment 12 to 15, wherein the multilayer composite has a peel strength, when adhered to a stainless steel panel and tested according to PSTC 101, of at least 0.5 lbs per inch.

Embodiment 17. The multilayer composite of any of Embodiment 12 to 16, wherein the multilayer composite is a roofing membrane, a paper label, tape, graphic art or a medical tape.

Embodiment 18. An underlayment, comprising a substrate and the composition of any of Embodiment 1 to 11.

Embodiment 19. The underlayment of Embodiment 18, further comprising a release liner.

Embodiment 20. The underlayment of Embodiment 17 or 18, wherein the substrate is selected from the group consisting of nonwoven polypropylene, nonwoven polyethylene, nonwoven polyethylene terephthalate, woven polypropylene, woven polyethylene, spunbond polypropylene, spunbond polyester, and combinations thereof.

Embodiment 21. A roof assembly comprising the underlayment of Embodiment 17 to 19.

Embodiment 22. A process for forming a multilayer composite, the process comprising:
(a) polymerizing a mixture comprising a monomer A, a monomer B, and a monomer C, in an amount of from 90% to 99.5% by weight,
   and a crosslinker in an amount from 0.5% to 10% by weight, based on total weight of the acrylic polymer, to provide a thermally curable pressure-sensitive adhesive,
(b) heating the thermally curable pressure-sensitive adhesive,
(c) extruding the adhesive to a planar surface of a polymeric membrane such that adhesive is in contact with substantially all of one planar surface of the polymeric membrane, forming an adhesive coating layer comprising the adhesive;
wherein the adhesive coating layer has a thickness of from 5 to 500 μm,
(d) subjecting the adhesive coating layer to thermal energy;
(e) optionally, cooling the adhesive coating layer;
(f) applying a release liner to the adhesive coating layer to form a multilayer composite; and
(g) winding the composite.

Embodiment 23. The process of Embodiment 22, wherein subjecting the coating to thermal energy comprises subjecting the adhesive coating layer to a temperature from 100° C. to 200° C. for a duration of from 5 min to 15 min.

Embodiment 24. A method for roofing a structure comprising
(a) providing the multilayer composite of any of Embodiment 12 to 17,
(b) removing the release liner from the multilayer composite forming linerless multilayer composite, and
(c) adhering/laminating/installing the linerless multilayer composite onto a roof substructure forming a roof laminate.

Embodiment 25. The method of Embodiment 24, wherein the linerless multilayer composite is installed at a temperature of from about −10° C. to about 80° C.

Embodiment 26. The composition of Embodiment 9, wherein the glycidyl copolymer comprises a glycidyl ether or a glycidyl amine.

Embodiment 27. The composition of Embodiment 1, wherein the crosslinker comprises a carbodiimide, an oxazoline, a peroxide, an azo, a cumene, a glycidyl amine, an adipic acid dihydrazide (ADDH), organometallic compounds, cyanoacrylate compounds, compounds including 1,3-diketo groups, an epoxidized soybean oil, an aziridine, a polyimine, or a polyamine.

Embodiments 2-27 may comprise a tackifier. The tackifier comprises a natural resin or an ester of hydrogenated gum rosin. The natural resin comprises a rosin, a rosin derivative, polyterpene resins, terpene-phenolic resins, alkylphenol resins, and aliphatic, aromatic and aliphatic-aromatic hydrocarbon resins, and combinations thereof.

In an Embodiment 28, the process of Embodiment 22 comprising adding a tackifier before (b) heating the thermally curable pressure-sensitive adhesive.

The foregoing embodiments are just that and should not be read to limit or otherwise narrow the scope of any of the inventive concepts otherwise provided by the instant disclosure. While multiple embodiments are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

FIG. 1 shows differential scanning calorimetry (DSC) results for a mixture of polyacrylate and crosslinker as described in Example 2.

FIG. 2 shows a schematic of the multilayer composition described herein.

### DETAILED DESCRIPTION OF THE INVENTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. When ranges are listed in the specification and in the claims, it is understood that all the numbers including decimals within the range are included whether specifically disclosed. For example, if the range is from 1 to 10, the range would include every number within the range, such as 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 and 10.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” or “derived from” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Provided herein are thermally curable hot-melt pressure sensitive adhesive compositions, a multilayer composite comprising a polymeric membrane, a hot-melt adhesive layer comprising a thermally curable pressure-sensitive adhesive, and a release liner, each component described in detail below, and methods for making the composite.

### Polymeric Membrane/Substrate

According to various embodiments described herein, the polymeric membrane may be a thermoplastic membrane, an ethylene-propylene-diene terpolymer rubber (EPDM) based membrane, a TPO based membrane, a PVC based membrane, a membrane based on other polymerics such as nonwoven polypropylene, nonwoven polyethylene, nonwoven polyethylene terephthalate, woven polypropylene, woven polyethylene, spunbond polypropylene, spunbond polyester, and combinations thereof; a rubber membrane, an asphaltic membrane, a fibrous membrane, and a flexible membrane selected from the group consisting of BOPP (bi-axially oriented polypropylene), polyethylene terephthalate (PET), and polyethylene furanoate (PEF), and polytrimethylene furandicarboxylate (PTF). These membranes may be flexible, rollable or in sheet form.

The thermally-curable hot melt adhesive composition of the present invention may be used in various applications. For example, a pressure-sensitive adhesive layer comprising the hot melt adhesive composition of the present disclosure may be used as a pressure-sensitive adhesive sheet. Suitable applications for the use of a laminate containing the pressure-sensitive adhesive layer may include pressure-sensitive adhesives, tapes and/or films for surface protection, masking, binding, packaging, office uses, labels, decoration/display, bonding, dicing tapes, sealing, corrosion prevention waterproofing, medical/sanitary uses, prevention of glass scattering, electrical insulation, holding and fixing of electronic equipment, production of semiconductors, optical display films, pressure-sensitive adhesion-type optical films, shielding from electromagnetic waves, and sealing materials in electric and electronic parts.

When the thermally-curable hot melt adhesives of the present disclosure are used in labels, suitable substrates for the labels may include plastic products, such as plastic bottles and foamed plastic cases; paper or corrugated fiberboard products, such as corrugated fiberboard boxes; glass products, such as glass bottles; metal products; and other inorganic material products, such as ceramic products. In one or more embodiments, the membrane includes EPDM membranes including those that meet the specifications of the ASTM D-4637. In other embodiments, the membrane includes thermoplastic membranes including those that meet the specifications of ASTM D-6878-03.

The polymer membrane is not particularly limited in its thickness. However, for commercial applications, and particularly for those in the roofing industry, the polymeric membrane has a thickness of from about 500 μm to about 3 mm, from about 1,000 μm to about 2.5 mm, or from about 1,500 μm to about 2 mm. For example, for label, tape, graphics and medical applications, the range can vary from about 1 microns to about 300 microns, or from about 2 microns to about 250 microns, or from about 3 microns to about 200 microns, or from about 5 microns to about 150 microns, or may have a thickness encompassed within any of these ranges.

In one or more embodiments, instead of a polymeric membrane a substrate is contemplated. Generally, the substrate is more rigid compared to a polymeric membrane. For examples, substrate may be gypsum, oriented strand board (OSB), metal and plywood. The substrate is not particularly limited in its thickness.

### Thermally Curable Hot-Melt Adhesive Composition

According to various embodiments described herein, the thermally curable hot-melt adhesive composition may include an acrylic copolymer and a crosslinker. The composition may be used for forming a pressure-sensitive adhesive layer.

### Acrylic Copolymer

As used herein, the term “theoretical glass transition temperature” or “theoretical Tg” refers to the estimated Tg of a polymer or copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below

$$1 / {T}_{g} = wa / {T}_{ga} + wb / {T}_{gb} + … + wi / {T}_{gi}$$

where wa is the weight fraction of monomer a in the copolymer, T_{ga} is the glass transition temperature of a homopolymer of monomer a, wb is the weight fraction of monomer b in the copolymer, T_{gb} is the glass transition temperature of a homopolymer of monomer b, wi is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

“Copolymer” refers to polymers containing two or more monomers.

According to various embodiments described herein, the acrylic copolymer maybe based on a polymerization of a monomer A, a monomer B, and a monomer C.

According to various embodiments described herein, monomer A may include methyl, ethyl, propyl, isoamyl, isooctyl, n-butyl, isobutyl, tert-butyl, cyclohexyl, 2-ethylhexyl, decyl, lauryl or stearyl acrylate and/or methacrylate, and any mixture thereof.

According to various embodiments described herein, monomer A may have a Tg of less than −20° C. For example, the Tg may be −30° C. or less, −40° C. or less, −45° C. or less, −50° C. or less, −55° C. or less, or −60° C. or less. The glass transition temperature can be determined by differential scanning calorimetry (DSC) by measuring the midpoint temperature using ASTM D 3418-12e1.

According to various embodiments described herein, monomer B may include acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and-methacrylamide, maleic acid monoamide and diamide, itaconic acid monoamide and diamide, fumaric acid monoamide and diamide, vinylsulfonic acid or vinylphosphonic acid, and mixtures thereof.

According to various embodiments described herein, monomer C may include methyl acrylate, methyl methacrylate, ethyl methacrylate, n-butyl methacrylate, tert-butyl methacrylate, tert-butyl acrylate, isobutyl methacrylate, vinyl acetate, hydroxyethyl acrylate, hydroxyethyl methacrylate, cyclohexyl acrylate, cyclohexyl methacrylate, 2-ethoxyethyl methacrylate, 2-phenoxyethyl methacrylate, benzyl acrylate, benzyl methacrylate, hydroxypropyl methacrylate, styrene, 4-acetostyrene, acrylamide, acrylonitrile, 4-bromostyrene, n-tert-butylacrylamide, 4-tert-butylstyrene, 2,4-dimethylstyrene, 2,5-dimethylstyrene, 3,5-dimethylstyrene, isobornyl acrylate, isobornyl methacrylate, 4-methoxystyrene, methylstyrene, alpha methylstyrene, 4-methylstyrene, 3-methylstyrene, 2,4,6-trimethylstyrene, vinyl pyrrolidone, ureido methacrylate and combinations thereof.

According to some embodiments, the acrylic copolymer may contain monomer A in an amount of from 50% by weight to 99.99% by weight based on the weight of the monomers A, B and C in the copolymer.

According to some embodiments, the acrylic copolymer may contain monomer B in an amount of from 0.1% by weight to 25% by weight based on the weight of the monomers A, B and C in the copolymer.

According to some embodiments, the acrylic copolymer may contain monomer C in in an amount of from 0.1% by weight to 25% by weight based on the weight of the monomers A, B and C in the copolymer.

The acrylic copolymer may include some percentage of carboxylic acid functionality, for example acrylic acid. The acrylic acid functionality may be present in an amount of about 5 wt. % or greater, about 6 wt. % or greater, about 7 wt. % or greater, about 8 wt. % or less, about 9 wt. % or less, about 10 wt. % or less, or any value encompassed by these endpoints, based on the total weight of the polymer.

The acrylic copolymer can be prepared by known processes.

The weight average molecular weight (M_{w}) of the acrylic copolymer can be, for example, 150,000 Da or more (e.g., 160,000 Da or more, 170,000 Da or more, 180,000 Da or more, 190,000 Da or more, 200,000 Da or more, 200,000 Da or more, 210,000 Da or more, 220,000 Da or more, 230,000 Da or more, 240,000 Da or more). In some examples, the weight average molecular weight (M_{w}) of the acrylic copolymer can be 250,000 Da or less (e.g., 240,000 Da or less, 230,000 Da or less, 220,000 Da or less, 210,000 Da or less, 200,000 Da or less, 190,000 Da or less, 180,000 Da or less, 170,000 Da or less, 160,000). The weight average molecular weight (M_{w}) of the acrylic copolymer can range from any of the minimum values described above to any of the maximum values described above. For example, the weight average molecular weight (M_{w}) of the acrylic copolymer can be from 150,000 Da to 250,000 Da (e.g., from 170,000 Da to 220,000 Da, or from 190,000 Da to 200,000 Da,). The weight average molecular weight (M_{w}) of the acrylic copolymer can be determined by GPC (gel permeation chromatography).

The number average molecular weight (Mₙ) of the acrylic copolymer can be, for example, 20,000 or more (e.g., 30,000 or more, or 40,000 or more). In some examples, the number average molecular weight (Mₙ) of the acrylic copolymer can be 50,000 or less (e.g., 40,000 or less, or 30,000 or less). The number average molecular weight (Mₙ) of the acrylic copolymer can range from any of the minimum values described above to any of the maximum values described above. For example, the number average molecular weight (Mₙ) of the acrylic copolymer can be from 20,000 to 50,000 (e.g., from 30,000 to 50,000, or from 40,000 to 50,000). The number average molecular weight (Mₙ) of the acrylic copolymer can be determined by GPC (gel permeation chromatography).

The dispersity ÐM calculated as M_{w}/Mₙ where Mw is the mass-average molar mass (or molecular weight) and Mₙ is the number-average molar mass (or molecular weight) of the acrylic copolymer may be more than 5 (e.g., more than 6, or more than 7, or more than 8, or more than 9 or more than 10). The dispersity of the acrylic copolymer may be less than 11 (e.g., less than 10, less than 9, less than 8, less than 7, or less than 6). The dispersity of the acrylic copolymer can range from any of the minimum values described above to any of the maximum values described above. For example, the dispersity of the acrylic copolymer can be from 5 to 11, or from 7 to 9.

### Crosslinkers

The thermally curable hot-melt adhesive composition may include one or more crosslinkers. The crosslinker may be a polymer (polymeric) or a copolymer. Alternatively, the crosslinker may be non-polymeric but could still be multi-functional. In some embodiments, polymeric crosslinkers may include water-dispersible carbodiimides, aromatic glycidyl ethers with terminally functional groups, glycidyl esters, silanes, or acetoacetoxy ethyl methacrylate (AAEM). In some embodiments, non-polymeric crosslinkers that are multi-functional may include hydrophobic carbodiimides, oxazolines, adipic acid dihydrazide (ADDH), glydicyl ethers, glycidyl amines, aliphatic epoxies, cyclo-aliphatic epoxies, polyisocyanates, silanes, polyamines, or polyimines.

Suitable co-polymer crosslinkers may withstand the high temperature in a hot-melt holding tank, allowing mixing, without causing premature gel formation. For improved compatibility, the crosslinker may comprise an acrylate or methacrylate or combination thereof, and include reactive functionality. The crosslinker may comprise an acrylate or methacrylate copolymer, including epoxy functionality that may comprise a glycidyl copolymer, such as glycidyl methacrylate, glycidyl esters, such as glycidyl acrylate, and silane coupling agents such as glycidoxyalkyl alkoxylsilanes, polyfunctional isocyanates, polyfunctional amines, polyfunctional alcohols, and polyfunctional acrylates. In some embodiments, the cross-linker may be based on a polyfunctional isocyanate, a glycidyl amine, or a multi-functional glycidyl ether. Compatibility of suitable crosslinkers may be indicated by a clear hot melt exhibiting no cloudiness.

In some embodiments, suitable crosslinkers comprising a multi-functional glycidyl ether may include, for example, Aliphatic Diglycidyl Ethers (e.g., commercially available as ERISYS® GE-20 distributed by Huntsman Corporation), 1,4 Cyclohexanedimethanol Diglycidyl Ether (e.g., commercially available as ERISYS® GE-22 distributed by Huntsman Corporation), Trimethylolpropane Triglycidyl Ether (e.g., commercially available as ERISYS® GE-30 distributed by Huntsman Corporation), Propoxylated Glycerin Triglycidyl Ether Aliphatic Trifunctional Flexibilizing Epoxy Reactive Diluent (e.g., commercially available as ERISYS® GE-36 distributed by Huntsman Corporation), Sorbitol Polyglycidyl Ether (e.g., commercially available as ERISYS® GE-60 distributed by Huntsman Corporation), or Dimer Acid Diglycidyl Ester, reactive diluent for epoxy resins (e.g., commercially available as ERISYS® GE-120 distributed by Huntsman Corporation).

In some embodiments, suitable crosslinkers comprising a glycidyl amine may be commercially available, such as for example, ERISYS® GA-240 by Huntsman Corporation. In certain embodiments, suitable crosslinkers comprising an ester of methacrylic acid and glycidol (glycidyl ester) may be commercially available, such as for example, glycidyl methacrylate (GMA) by Dow Chemical Company.

In some embodiments, suitable crosslinkers comprising a multi-functional glycidyl ether may include, for example, n-butyl glycidyl ether, glycidyl butanoate, or 1,4-butanediol diglycidyl ether. In certain embodiments, suitable crosslinkers may include an epoxy crosslinker such as, for example, 4-5-epoxynonane, or epoxy cyclohexane. In some embodiments, suitable crosslinkers comprising a multi-functional glycidyl ether may include an aromatic glycidyl ether of the below formula (Formula I):

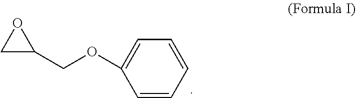 [SMILES: c1ccc(OCC2CO2)cc1]

In some embodiments, acrylate co-polymers are commercially prepared using free-radical polymerization methods (shown below in Formula II). High-temperature, near bulk radical polymerization, for example as described in U.S. Pat. Nos. 4,414,370A and 4,529,787B1, are sometimes preferred because the process is homogenous and results in a more appropriate (e.g. lower) molecular weight for a cross-linker. Typically, such (meth)acrylate compositions are comprised of one functional “cross-linkable monomer” and one or more “non-functional” monomers, which are chosen based on cost and/or other properties, such as Tg.

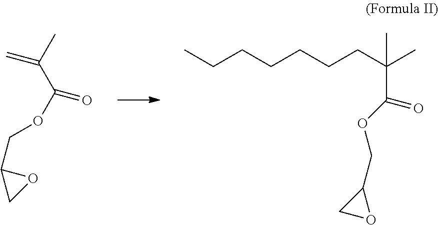

Exemplary acrylate and methacrylate monomers include, but are not limited to, methyl (meth)acrylate, ethyl (meth)acrylate, n-butyl (meth)acrylate, iso-butyl (meth)acrylate, t-butyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri(meth)acrylate, pentaerythritol tetra(meth)acrylate and combinations thereof.

In some embodiments, the crosslinker is derived from one or more monomers selected from the group consisting of ethyl (meth)acrylate, n-butyl (meth)acrylate, 2-ethylhexylacrylate, lauryl (meth)acrylate, glycidyl (meth)acrylate and combinations thereof.

Suitable crosslinkers may be commercially available, such as for example, JONCRYL® distributed by BASF. Suitable crosslinkers including aromatic glycidyl ethers may be commercially available, such as for example, Epon™ or Heloxy™ 62 by Miller-Stephenson Chemical Company. In some embodiments, suitable cyclo-aliphatic crosslinkers including an epoxy functionality may be commercially available, such as for example, Cyracure™ by Dow Chemical Company.

According to various embodiments described herein, the crosslinker may have a Tg of about 0° C. to about −60° C., and may have any value encompassed within this range.

The weight average molecular weight (M_{w}) of the crosslinker can be, for example, 2 Da or more, (e.g., 20 Da or more, 200 Da or more, 2,000 Da or more, 4,000 Da or more, 6,000 Da or more, 10,000 Da or more, 20,000 Da or more, 25,000 Da or more, 30,000 Da or more, 35,000 Da or more). In some examples, the weight average molecular weight (M_{w}) of the crosslinker can be 50,000 Da or less (e.g., 45,000 Da or less, 40,000 Da or less, 35,000 Da or less, 30,000 Da or less, 25,000 Da or less, 20,000 Da or less, 10,000 Da or less, 6,000 Da or less). The weight average molecular weight (M_{w}) of the crosslinker can range from any of the minimum values described above to any of the maximum values described above. For example, the weight average molecular weight (M_{w}) of the crosslinker can be from 2 Da to 50,000 Da (e.g., from 6,000 Da to 20,000 Da) or any value encompassed within this range. The weight average molecular weight (M_{w}) of the crosslinker can be determined by GPC (gel permeation chromatography).

The number average molecular weight (Mₙ) of the crosslinker can be, for example, 6 Da or more (e.g., 60 Da or more, 200 Da or more, 400 Da or more, 500 Da or more, 800 Da or more, 1,000 Da or more, 2,500 Da or more, 5,000 Da or more, 7,500 Da or more, 10,000 Da or more, 12,500 Da or more, 15,000 Da or more). In some examples, the weight average molecular weight (M_{w}) of the crosslinker can be 20,000 Da or less (e.g., 18,000 Da or less, 16,000 Da or less, 14,000 Da or less, 12,000 Da or less, 10,000 Da or less, 7,500 Da or less, 5,000 Da or less, 2,500 Da or less, 1000 Da or less). The weight average molecular weight (M_{w}) of the crosslinker can range from any of the minimum values described above to any of the maximum values described above. For example, the weight average molecular weight (M_{w}) of the crosslinker can be from 6 Da to 20,000 Da (e.g., from 1000 Da to 10,000 Da) or any value encompassed within this range. The number average molecular weight (Mₙ) of the crosslinker can be determined by GPC (gel permeation chromatography).

The viscosity of the crosslinker can be, for example, about 10,000 P or less at 25° C., or about 5,000 P or less, or about 1000 P or less, or about 100 P or less, or about 50 P or less, or about 1 P or less). The viscosity of the crosslinker can be, for example, about 1 P or more at 25° C., or about 50 P or more, or about 100 P or more, or about 1000 P or more, or about 5000 P or more). For example, the viscosity of the crosslinker can be from 1 P to 10,000 P (e.g., from 1000 P to 5000 P) or any value encompassed within this range.

At elevated temperatures, the copolymeric crosslinker becomes less viscous, enabling sufficient mixing to occur with the acrylate copolymer. The viscosity of the crosslinker can be, for example, the viscosity can from about 0.1 P to about 40 P at 125° C., or about 0.15 to about 30 P at 125° C., or about 0.2 to about 20 P at 125° C., or may be any value encompassed within these ranges. The viscosity can be measured using a temperature controlled rheometer using parallel plate or cone and plate configurations. Lower viscosities at room temperature can be measured directly using rotational viscometry.

It is to be understood that the crosslinker not only contains reactive functionality but also exhibits suitable flow behavior at room temperature, and has a viscosity suitable for mixing at elevated temperatures, where the reaction rate is still slow enough for control and a suitable pot-life. Preferably, the crosslinker may have pot-life ranging from about 1 minute to about 10 hours, or from about 2 minutes to about 10 hours, or from about 5 minutes to about 8 hours, or from about 8 minutes to about 6 hours, or from about 10 minutes to about 4 hours, or may have a pot-life of any value encompassed within these ranges.

The viscosity is not only a function of T_{g}, but is also a function of the cross-linker molecular weight. In general, viscosity exhibits an exponential dependence on polymer molecular weight according to standard theory, depending on whether polymer molecular weight is above or below the chain-entangle molecular weight.

There is an ideal balance to be obtained taking into account viscosity, the absolute concentration of reactive functionality, and its functionality per chain, which is defined as Fₙ=Mₙ/Eq Wt, where Eq Wt is the reactive functionality's equivalent weight and Mₙ is the number average molecular weight.

In some embodiments, that crosslinker may have a functionality per chain (Fn) of from about 1 to about 10.

The crosslinker may be combined with the copolymer in an amount of about 0.1 wt. % or greater (e.g., about 0.2 wt. % or greater, about 0.4 wt. % or greater, about 0.6 wt. % or greater, about 0.8 wt. % or greater, about 1 wt. % or greater, about 2.5 wt. % or greater, about 5 wt. % or greater, about 7.5 wt. % or greater, about 10 wt. % or greater). The crosslinker may be combined with the copolymer in an amount of about 15 wt. % or less (e.g., about 12 wt. % or less, about 10 wt. % or less, about 7.5 wt. % or less, about 5.0 wt. % or less, about 2.5 wt. % or less, about 1.0 wt. % or less, about 0.5 wt. % or less,) or any value encompassed by these endpoints, based on the total weight of the acrylic copolymer.

In some embodiments, the hot-melt adhesive may be combined with other additives to form the pressure-sensitive adhesive layer. Exemplary additives include, but are not limited to, tackifiers, fillers (e.g., calcium carbonate, fibers, carbon black, zinc oxide, titanium dioxide, chalk, solid or hollow glass beads, microbeads of other materials, silica, silicates), low-temperature plasticizers, nucleators, expandants, flow additives, fluorescent additives, polyolefins, rheology modifiers, compounding agents and/or aging inhibitors in the form of primary and secondary antioxidants or in the form of light stabilizers, photoinitiators, pigments, dyes, or mixtures thereof. The coating can be applied to a surface and dried to produce a pressure-sensitive adhesive coating. The pressure sensitive adhesives disclosed herein can be produce strippable (temporary) or permanent adhesive bonds.

Exemplary tackifiers (tackifying resins) include, but are not limited to, natural resins, such as rosins and their derivatives formed by disproportionation or isomerization, polymerization, dimerization and/or hydrogenation. Tackifiers can include rosin and rosin derivatives (rosin esters, including rosin derivatives stabilized by, for example, disproportionation or hydrogenation) polyterpene resins, terpene-phenolic resins, alkylphenol resins, and aliphatic, aromatic and aliphatic-aromatic hydrocarbon resins, and combinations thereof. In some embodiments, the tackifying resins can be present in salt form (with, for example, monovalent or polyvalent counterions (cations)) or in esterified form. Alcohols used for the esterification can be monohydric or polyhydric. Exemplary alcohols include, but are not limited to, methanol, ethanediol, diethylene glycol, triethylene glycol, 1,2,3-propanethiol, and pentaerythritol.

Exemplary hydrocarbon tackifying resins include, but are not limited to, coumarone-indene resins, polyterpene resins, and hydrocarbon resins based on saturated CH compounds such as butadiene, pentene, methylbutene, isoprene, piperylene, divinylmethane, pentadiene, cyclopentene, cyclopentadiene, cyclohexadiene, styrene, a-methylstyrene, and vinyltoluene.

In some embodiments, the tackifying resins are derived from natural rosins. In some embodiments, the tackifying resins are chemically modified rosins. In some embodiments, the tackifying resins are fully hydrogenated. In some embodiments, the rosins comprise abietic acid or abietic acid derivatives. Exemplary commercially available tackifiers include, but are not limited to, FORAL® AX-E, FORAL® 85, and REGALRITE® 9100 by Eastman Chemical Company.

In some embodiments, the acrylic copolymer does not include a solvent.

### Silane-Based Crosslinkers

In some embodiments, the thermally curable hot-melt adhesive composition may include one or more crosslinkers including silane coupling agents. Silane coupling agents have the general structural formula of R—(CH₂)ₙ—Si—X₃ (where R is an organofunctional group, and X₃ are hydrolysable groups). As shown, the general formula for a silane coupling agent may include two classes of functionality. In some embodiments, X is a hydrolysable group that may include alkoxy, acyloxy, halogen or amine. In certain embodiments, the R group is a nonhydrolyzable organic radical that may possess a functionality that imparts desired characteristics.

In some embodiments, suitable silane coupling agents for use as crosslinkers may include monoamine functional silanes such as 4-amino-3,3-dimethylbutyltrimethoxysilane; dipodal amine functional silanes such as bis(3-triethoxysilylpropyl)amine; epoxy functional silanes such as 2-(3,4-epoxycyclohexyl)ethyltriethoxysilane, 2-(3,4-epoxycyclohexyl)ethyltrimethoxysilane, 5,6-epoxyhexyltriethoxysilane, (3-glycidoxypropyl)triethoxysilane, (3-glycidoxypropyl)trimethoxysilane; halogen functional silanes such as 3-chloropropyltriethoxysilane; masked isocyanate functional silanes such as tris(3-trimethoxysilylpropyl)isocyanurate; or sulfur functional silanes such as 3-mercaptopropyltrimethoxysilane.

### Carbodiimide-Based Crosslinker

In some embodiments, the thermally curable hot-melt adhesive composition may include one or more crosslinkers including compounds containing carbodiimide groups.

Carbodiimide groups have the general structural formula —N═C═N—.

Suitable compounds containing carbodiimide groups (carbodiimides for short) may contain in general on average from about 2 to about 20, or from about 2 to about 15, or from about 2 to about 10, carbodiimide groups, or may contain carbodiimide groups of any value encompassed within these ranges.

The number-average molar weight Mn of the carbodiimides may be from about 400 to about 10000, or from about 800 to about 5000, or from about 1000 to about 2000 g/mol, or may have a number-average molar weight of any value encompassed by these endpoints.

The number-average molecular weight is determined by end group analysis utilizing Proton Nuclear Magnetic Resonance (HNMR) if end group analysis is not possible, by gel permeation chromatography (polystyrene standard, THF as eluent).

Carbodiimide groups are obtainable in a simple way from two isocyanate groups (shown below as Formula III and Formula IV), with elimination of carbon dioxide:

—R—N═C═O+O═C═N—R (Formula III)

—R—N═C═N—R—+CO₂ (Formula IV)

Starting from polyisocyanates or diisocyanates it is possible in this way to obtain carbodiimides containing two or more carbodiimide groups. In some embodiments, terminal isocyanate groups are quenched or capped using a mono alcohol. In some embodiments, polyisocyanates that are suitable for use may include aromatic polyisocyanates (e.g., commercially available as Basonat® distributed by BASF, or Desmodur® distributed by Covestro). In some embodiments, polyisocyanates that are suitable for use may include aliphatic polyisocyanates (e.g., commercially available as Basonat® distributed by BASF, or Desmodur® distributed by Covestro).

Carbodiimides (CDIs) are typically classified as either aromatic or aliphatic depending on the corresponding isocyanate used to make it. It is also possible to make mixed aromatic-aliphatic CDIs. Examples of suitable diisocyanates include diisocyanates X(NCO)₂, where X is an aliphatic hydrocarbon radical having 4 to 12 carbon atoms, a cycloaliphatic or aromatic hydrocarbon radical having 6 to 15 carbon atoms, or an araliphatic hydrocarbon radical having 7 to 15 carbon atoms. Examples of such diisocyanates include methylene diphenyl diisocyanate (MDI), isophorone diisocyanate (IPDI), 2,4-toluene diisocyanate (2,4-TDI), tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane, 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanato-diphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomers, and mixtures of these compounds. In some embodiments, preference is given to TMXDI.

As a result of the terminal isocyanate groups the carbodiimide can easily be hydrophilically modified, by reaction with amino acids or hydroxyl, for example. Hydrophilically modified carbodiimides are easier to mix with aqueous adhesives or adhesives based on hydrophilic polymers.

According to some embodiments, it is possible to attach the carbodiimides to the acrylic copolymers, for example by reacting the isocyanate group with a reactive group of the acrylic copolymer, such as an amino group or hydroxyl group.

In some embodiments, if appropriate, it is advantageous to block the terminal isocyanate groups, so that the carbodiimide compounds have nonreactive end groups. For this purpose the terminal isocyanates are with particular preference reacted with compounds which have only one isocyanate-reactive group, such as with monohydric alcohols.

In some embodiments, suitable carbodiimide-based crosslinkers may include aromatic CDIs, aliphatic CDIs, or mixed aromatic-aliphatic CDIs. In certain embodiments, suitable carbodiimide-based crosslinkers may be water-dispersible. In certain embodiments, suitable carbodiimide-based crosslinkers may be hydrophobic. In some embodiments, suitable carbodiimide-based crosslinkers may be acid cross-linkable if forming an N-acyl urea. Examples of suitable carbodiimide used in the crosslinker component include, for example, 2,2′,6,6′-tetraisopropyldiphenylcarbodiimide.

Suitable crosslinkers may be commercially available, such as for example, BASONAT® distributed by BASF (e.g., Basonat® DS 3582), ELASTOSTAB® distributed by BASF (e.g., ELASTOSTAB® H01 and H03), Stabaxol® distributed by Lanxess AG (formerly Bayer AG), Zoldine™ by Advancion Sciences (formerly Angus Chemical Company), Picassian® XL-701 by Stahl Polymers, Carbodilite™ by Nisshinbo Chemical Inc., or Astacin® Hardener CN by Austral Chemicals.

In some embodiments, the carbodiimide-based crosslinkers may include at least one silane group bonded by way of urea groups, for example as described in U.S. Pat. No. 7,498,379B2 to BASF. In certain embodiments, the carbodiimide-based crosslinkers may include compounds synthesized from diisocyanates and polyalkylene oxides, for example as described in U.S. Pat. No. 7,816,462B2 to BASF.

The crosslinker may be combined with the acrylate copolymer in an amount of from about 0.05 to about 10% by weight, or from about 0.1 to about 5% by weight, based on the total weight of the acrylic copolymer.

Due to the synthesis methods, CDIs may be lower in molecular weight than acrylic counterparts. In some embodiments, hydrophilic modifications may add considerably—as a non-functional portion—to the molecular weight of CDIs.

### Oxazoline-Based Crosslinker

In some embodiments, the thermally curable hot-melt adhesive composition may include one or more crosslinkers including compounds containing oxazoline monomers such as those described in U.S. Pat. No. 10,336,849B2 to BASF, incorporated herein by reference.

In certain embodiments, suitable oxazoline-based crosslinkers may be water-dispersible. Suitable crosslinkers may be commercially available, such as for example, EPOCROS™ by Nippon Shokubai.

### Free Radical Initiators

According to some embodiments, the thermally curable hot-melt adhesive composition may include one or more crosslinkers including compounds containing free radical initiators. In some embodiments, crosslinker with free radical initiators is not specifically limited as long as it can undergo homolytic fission to generate free radicals.

In some embodiments, free radical initiators such as peroxides can be used to induce cross-linking with the acrylate polymer. Classes of peroxides include dialkyl peroxydicarbonates, diacyl peroxides, t-alkyl peroxyesters, t-alky diperoxyketals, t-alkyl hydroperoxides, di(t-alkyl) peroxides, and ketone peroxides. Peroxides should be selected based on volatility, the temperature of decomposition, and the radical “hot-ness” of the radical. Peroxides are often ranked according to their one-hour t_{1/2} temperature (e.g. the temperature at which half the initiator is thermally cleaved by first-order decay). Radical hot-ness relates to the energetics of the free-radical to abstract a hydrogen atom.

Examples of suitable crosslinkers include tert-butyl hydroperoxide, tert-butyl peroxyacetate, cumene hydroperoxide, 2,5-di(tert-butylperoxy)-2,5-dimethyl-3-hexyne, dicumyl peroxide, 2,5-bis(tert-butylperoxy)-2,5-dimethylhexane, 2,4-pentanedione peroxide, 4-hydroxy-4-methyl-2-pentanone, N-methyl-2-pyrrolidone, 1,1-bis(tert-butylperoxy)-3,3,5-trimethylcyclohexane, 1,1-bis(tert-butylperoxy)cyclohexane, 1,1-bis(tert-amylperoxy)cyclohexane, butanone peroxide, tert-butyl peroxide, lauroyl peroxide, tert-butyl peroxybenzoate, tert-butylperoxy 2-ethylhexyl carbonate, tert-butyl hydroperoxide, 4,4′-azobis(4-cyanovaleric acid), ammonium persulfate, hydroxymethanesulfinic acid monosodium salt dihydrate, potassium persulfate, sodium persulfate or the like, or a combination thereof. In an embodiment, the coinitiator is 1,1,2,2-tetraphenyl-1,2-ethanediol.

In some embodiments, the crosslinkers with free radical initiators may include an organic compound with peroxide functionality selected from didecanoyl peroxide, dilauroyl peroxide, succinic acid peroxide, dibenzoyl peroxide, dicumyl peroxide, 2,5-di-(tert-butylperoxy)-2,5-dimethylhexane, tert-butyl cumyl peroxide, α,α′-bis-(tert-butylperoxy)-diisopropylbenzene, di-tert-amyl peroxide, di-tert-butyl peroxide, 2,5-di-(tert-butylperoxy)-2,5-dimethyl-3-hexyne, 1,1-di-(tert-butylperoxy)-3,3,5-trimethylcyclohexane, 1,1-di-(tert-butylperoxy)-cyclohexane, 1,1-di-(tert-amylperoxy) cyclohexane, n-butyl 4,4-di-(tert-butylperoxy)valerate, ethyl 3,3-di-(tert-amylperoxy)butanoate, ethyl 3,3-di-(tert-butylperoxy)butyrate and tert-butylperoxy 2-ethylhexyl carbonate. In certain embodiments, the crosslinker may be di-tert-butyl peroxide (Di-TBP).

In some embodiments, crosslinkers may be compounds that are radical-forming under thermal conditions, such as an azo compound, for example 2,2′-azobis(4-methoxy-2,4-dimethylvaleronitrile), a triazene, a diazosulfide, a pentazadiene or a peroxy compound, such as, for example, a hydroperoxide or peroxycarbonate, for example tert-butyl hydroperoxide, or thermolatent radical initiators as described for example in U.S. Pat. No. 6,929,896, WO 2010057922, WO2012113829, WO2012101245, WO2013156509 or WO2014064064. The addition of redox initiators, such as cobalt salts, enables the curing to be assisted by oxidative crosslinking with oxygen from the air. In some embodiments, crosslinkers may be compounds that are radical-forming under thermal conditions, such as a di-azo compound.

In some embodiments, crosslinkers with free radical initiators may include organic peroxides, such as benzoyl peroxide, tert-butyl hydroperoxide, methyl ethyl ketone peroxide, cumene hydroperoxide, azo compounds such as azobisiso-butyronitrile (AIBN) and also inorganic peroxy compounds such as (NH₄)₂S₂O₈, K₂S₂O₈ or H₂O₂. AIBN may be commercially available, for example, under the VAZO name as Vazo™ 64 by Chempoint®.

In some embodiments, the crosslinker with free radical initiators are present in an amount of from about 0.5 to about 10 wt %, or from about 1 to about 5 wt %, or from about 1.5 to about 2.5 wt %, or may be present in an amount of any value encompassed by these endpoints based on the total weight of the acrylic copolymer.

In some embodiments, the free radical initiators may include peroxides such as di(3-carboxypropionyl) peroxide, a-cumyl peroxyneodecanoate, 2-hydroxy-1,1-dimethylbutyl peroxyneoheptanoate, a-cumyl peroxyneoheptanoate, t-amyl peroxyneodecanoate, and t-butyl peroxyneodecanoate. In some embodiments, the peroxides may require mixing and/or thermal activation. Exemplary commercially available peroxides include, but are not limited to, Luperox® SAP, Luperox® 188, Luperox® 688, Luperox® 288, Luperox® 546, and Luperox® 10 by Arkema Inc.

### Polyamine/Polyimine-Based Crosslinkers

In some embodiments, the thermally curable hot-melt adhesive composition may include one or more crosslinkers including polyamine crosslinking agents or polyimine polymers.

Non-limiting examples of polyamine crosslinking agents include diethyltoluenediamine, chlorodiaminobenzene, diethanolamine, diisopropanolamine, triethanolamine, tripropanolamine, 1,6-hexanediamine, and combinations thereof. Typical diamine crosslinking agents comprise twelve carbon atoms or fewer, more commonly seven or fewer. Examples of such crosslinking agents include Diethanolamine pure (BASF) or Glycerine (DOW). The polyamine crosslinking agents may represent from about 0.05 wt. % to about 3 wt. % based on the total weight of the acrylic copolymer.

Polyimine polymers are characterized by the presence of recurring —N—R″— groups as integral parts of the main polymer chain. Typical structural formula of linear polyimines may be represented as

H₂—N—R″[N—R″]ₙ—NH₂ (Formula V)
wherein n represents the degree of polymerization or number of recurring groups in the polymer chain.

In the above formula, R″ may be a hydrocarbon group selected from the group consisting of alkylene, aralkylene, cycloalkylene, arylene, and alkarylene, including such radicals when inertly substituted. When R″ is alkylene, it may typically be methylene, ethylene, n-propylene, iso-propylene, n-butylene, i-butylene, secbutylene, amylene, octylene, decylene, octadecylene, etc. When R″ is aralkylene, it may typically be benzylene, betaphenylethylene, etc. When R″ is cycloalkylene, it may typically be cyclohexylene, cycloheptylene, cyclooctylene, 2-methylcycloheptylene, 3-butylcyclohexylene, 3-methylcyclohexylen etc. When R″ is arylene, it may typically be phenylene, naphthylene, etc. When R″ is alkarylene, it may typically be tolylene, xylylene, etc.

R″ may be inertly substituted (e.g., it may bear a non-reactive substitutent such as alkyl, aryl, cycloalkyl, ether, etc). In some embodiments, inertly substituted R″ groups may include 3-methoxypropylene, 2-ethoxyethylene, carboethoxymethylene, 4-methylcyclohexylene, p-methylphenylene, p-methylbenzylene, 3-ethyl-5-methylphenylene, etc.

In some embodiments, R″ groups may be phenylene or lower alkylene, for example, C₁-C₁₀ alkylene groups including e.g. methylene, ethylene, n-propylene, i-propylene, butylene, amylene, hexylene, octylene, decylene, etc. In certain embodiments, R″ may be phenylene or ethylene —CH₂—CH₂—.

In some embodiments, the polyimine polymers has a molecular weight of from about 40,000 to 100,000, or a molecular weight of about 60,000.

### Other Crosslinkers

According to some embodiments, the thermally curable hot-melt adhesive composition may include one or more crosslinkers including compounds containing solvent borne crosslinkers, for example dihydrazides, in particular aliphatic dicarboxylic acid dihydrazides such as adipic acid dihydrazide (ADDH) as described in U.S. Pat. No. 4,931,494, US 2006/247367 and US 2004/143058. In some embodiments, the crosslinker is selected from aliphatic dicarboxylic acid dihydrazides, such as adipic acid dihydrazide (ADDH) and/or polyamines, such as low molecular weight diamines, polyetheramines and polyaziridines, for example as described in WO2023057249A1 to BASF. Suitable crosslinkers may be commercially available, such as for example, ADH sold by Gantrade Corporation.

In some embodiments, the thermally curable hot-melt adhesive composition may include one or more crosslinkers including compounds containing organometallics including, for example, aluminum aceto-acetate (AAA), zinc, or metal chelates having ionic or radical initiators. In some embodiments, these multivalent metal ions based on zinc, chromium, titanium, zirconium and aluminum etc. will react with carboxylic acid groups and form ionic bonds that facilitate cross linking. In some embodiments, depending on the metal ion diffusion rates, the kinetics of the cross linking reaction will change and can be used for various applications where kinetics helps to cure at the right speed. This cross linking reaction will increase the cohesive strength of the polymer.

In some embodiments, the thermally curable hot-melt adhesive composition may include one or more crosslinkers containing an alkylation agent. In certain embodiments, the alkylation agent may be nucleophilic. In some embodiments, the alkylation agent may be electrophilic. In certain embodiments, the alkylation agents may include alkyl haloalkanoates such as methyl chloroacetate, or methyl bromoacetate.

In some embodiments, the thermally curable hot-melt adhesive composition may include one or more crosslinkers including compounds containing cyanoacrylates (e.g., alkyl cyanoacrylates or alkyl cyanoacrylate polymers). In embodiments, where cyanoacrylates are used as crosslinkers, the monomers A, B, or C of the composite may anionically cure upon moisture exposure, and may not utilize an acid. In some embodiments, suitable cyanoacrylates may be commercially available as Loctite® distributed by Henkel Corporation.

In some embodiments, the thermally curable hot-melt adhesive composition may include one or more crosslinkers including epoxy alternatives. In certain embodiments, epoxy alternatives include epoxy plasticizers such as epoxidized vegetable oils, such as soybean oil and Vernonia oil.

In some embodiments, the thermally curable hot-melt adhesive composition may include one or more crosslinkers including aziridine-based crosslinking agents, for example, trimethylolpropane tris(beta-aziridino)propionate, or 1,6-bis-N-aziridinohexane. In some embodiments, crosslinkers including polyaziridine may be commercially available as, for example, NeoAdd™ PAX crosslinkers by DSM.

In some embodiments, the thermally curable hot-melt adhesive composition may include one or more crosslinkers including a sulfur-based crosslinking component. In some embodiments, the sulfur-based crosslinking component may be monosulfidic (—C—S—C—), or disulfidic (—C—S₂—C—), or polysulfidic (—C—Sₓ—C—, x>=3). Suitable sulfur-based crosslinkers may include, for example, tetramethyl triuram disulfide (commercially available as TMTD by Akrochem), 4,4′-dithiodimorpholine (commercially available as DTDM by Akrochem), dipentamethylene thiuram tetrasulfide (commercially available as DPTT by Akrochem), or thiocarbamyl sulfenamide (commercially available as Cure-Rite 18 by Akrochem).

In some embodiments, the thermally curable hot-melt adhesive composition may include one or more crosslinkers including acetoacetoxy ethyl methacrylate (AAEM). In some embodiments, crosslinkers including AAEM may be commercially available as, for example, Eastman™ AAEM.

In some embodiments, the thermally curable hot-melt adhesive composition may include one or more crosslinkers including compounds containing catalyst and crosslinker packages. In some embodiments, the ideal rate of cure, e.g. cross-linking, may be dialed in by using a catalyst. This is particularly true if the inherent rate of cross-linking is too slow. For instance, the cross-linking by certain epoxy-based chemistries such as glycidyl ethers, and epoxidized oils can be accelerated with imidazole catalysts, quaternary ammonium salts and organo-zinc compounds. Example catalysts include 2-propylimidazole, tetrabutyl ammonium bromide, and zinc octoate.

### Release Liner

According to various embodiments described herein, the release liner may be a polymeric film or extrudate based on polypropylene, polyester, high-density polyethylene, medium-density polyethylene, low-density polyethylene, polystyrene or high-impact polystyrene, a siliconized release liner or a cellulosic substrate. It is known in the art that a coating or layer may be applied to the film and/or cellulosic substrate, and that it may include a silicon-containing or fluorine-containing coating. These coatings include, for example, silicone oil, polysiloxane or hydrocarbon waxes.

According to various embodiments described herein, the release liner may have a thickness of from 50 μm to 500 μm.

### Preparation of Multilayer Composite

A multilayer composite comprising the polymeric membrane described above, the acrylic copolymer described above, and the release liner described above may be prepared using the following steps:
(a) polymerizing a mixture comprising the monomers A, B, and C described above in an amount of from 90% to 99.5% by weight, and a crosslinker in an amount from 0.5% to 10% by weight, based on total weight of the acrylic polymer, to provide a thermally curable pressure-sensitive adhesive,
(b) heating the thermally curable pressure-sensitive adhesive,
(c) extruding the adhesive to a planar surface of a polymeric membrane such that adhesive is in contact with substantially all of one planar surface of the polymeric membrane, forming an adhesive coating layer comprising the adhesive;
(d) subjecting the adhesive coating layer to thermal energy;
(e) optionally, cooling the adhesive coating layer;
(f) applying a release liner to the adhesive coating layer to form a multilayer composite; and
(g) winding the composite.

In step (a), the crosslinker may comprise an acrylate or methacrylate copolymer, including epoxy functionality that may comprise glycidyl methacrylate, glycidyl esters, such as glycidyl acrylate, and silane coupling agents such as glycidoxyalkyl alkoxylsilanes, polyfunctional isocyanates, polyfunctional amines, polyfunctional alcohols, and polyfunctional acrylates. In some embodiments, the crosslinker may be based on a polyfunctional isocyanate or a multi-functional glycidyl ether.

In step (a), the crosslinker may be derived from one or more monomers selected from the group consisting of ethyl (meth)acrylate, n-butyl (meth)acrylate, 2-ethylhexylacrylate, lauryl (meth)acrylate, glycidyl (meth)acrylate and combinations thereof.

Alternatively, step (a) may include in-line mixing of a crosslinker and the acrylic copolymer. For example, the crosslinker may be mixed into the polymerizing copolymer at either elevated temperature or room temperature.

For example, the acrylic hot melt and the glycidyl acrylate may be in-line mixed at 100-160 C with residence time<2 mins to avoid gelation. In line mixing can be facilitated by a static mixer or mixing extruder which is connected to a slot die coating head to dispense the desired coating of hot melt adhesive mixture at a desired coating thickness at 100-160 C. After coating the adhesive onto a substrate, the coating is subjected to higher temperature to thermally cured the adhesive coating rapidly. The high temperature source may be an Infra-Red (IR) heater or a high velocity impingement air convection oven or a microwave, the selection depends on the nature of the substrate and the coating. The high temperature source may also comprise acoustic supported heating, for example, ultrasonic assisted air convection ovens. The goal is to obtain uniform cured coating without damaging the substrate within a practical time frame.

In step (b), the hot-melt adhesive may be heated to a temperature of about 120° C. or greater, about 125° C. or greater, about 130° C. or greater, about 135° C. or greater, about 140° C. or greater, about 145° C. or less, about 150° C. or less, about 155° C. or less, about 160° C. or less, or any value encompassed by these endpoints.

Prior to or in step (b), a catalyst may be added to the thermally curable pressure-sensitive adhesive. The catalyst may include quaternary ammonium and phosphonium compounds, imidazoles, inorganic salts such as halides of Al, B, Be, Fe(III)19, Sb(V), Sn, Ti, Zr or Zn, halides of As, Sb(III), Co, Cu, Fe(II) and Hg, boron trifluoride, metal alkoxides, metal chelates, such as dionate complexes and metal oxides, such as barium oxide or strontium oxide, amine, such as 2-Ethylhexylamine, bis(2-ethylhexyl)amine tetrabutyl phosphonium bromide Proton sponge Dodecyldimethylamine, N,N-dimethylbenzylamine, 2-ethylimidazole, DBU/Octanoic acid Tetramethyl guanidine Benzyltrimethyl ammonium bromide, benzyltrimethyl ammonium hydroxide or tetrabutyl ammonium hydroxide.

In step (c), the curable hot-melt adhesives can be extruded simultaneously or sequentially onto the polymeric membrane by using known methods. The adhesive can then subsequently be cured by using, for example, thermal energy. The release film can be applied to the adhesive layer, and the membrane can then be subsequently rolled for storage and/or shipment. The multilayer composites according to embodiments of the present invention may be prepared by a single continuous process.

In the multilayer composite, the thermally curable pressure-sensitive adhesive layer may have a thickness of 5 μm to 500 μm, or from 5 μm to 250 μm, or from any of the minimum values described above to any of the maximum values described above.

Regarding step (d), it has surprisingly been found that thermally curing the hotmelt adhesives described herein may proceed very quickly, in contrast to solvent based compositions that may require hours to days of curing time.

Specifically, the thermal curing step subjects the adhesive coating to thermal energy for a period of time of about 1 second or greater, about 30 seconds or greater, about 1 minute or greater, about 3 minutes or greater, about 5 minutes or greater, about 6 minutes or greater, about 7 minutes or greater, about 8 minutes or greater, about 9 minutes or less, about 10 minutes or less, about 11 minutes or less, about 12 minutes or less, about 13 minutes or less, about 14 minutes or less, about 15 minutes or less, or any value encompassed by these endpoints. The coating may be thermally cured for a total period of time of about 20 minutes or greater, about 30 minutes or greater, about 1 hour or greater, about 5 hours or greater, about 12 hours or less, about 18 hours or less, about 24 hours or less, about 36 hours or less, about 48 hours or less, or any value or range encompassed by these endpoints. For example, the coating may be thermally cured for a total period of time of up to about 60 minutes.

During thermal curing, a temperature ramp may be used in which the temperature is raised over a period of time. The period of time may be about 1 minute or greater, about 2 minutes or greater, about 3 minutes or greater, about 4 minutes or greater, about 5 minutes or greater, about 6 minutes or greater, about 7 minutes or greater, about 8 minutes or less, about 9 minutes or less, about 10 minutes or less, about 11 minutes or less, about 12 minutes or less, about 13 minutes or less, about 14 minutes or less, about 15 minutes or less, or any value or range encompassing these endpoints.

The thermal curing step subjects the adhesive coating to a temperature of about 100° C. or greater, about 125° C. or greater, about 150° C. or greater, about 175° C. or less, about 200° C. or less, or any value encompassed by these endpoints.

As shown in FIG. 2, the multilayer composition 10 comprises the polymeric membrane 12, the thermally curable pressure-sensitive adhesive 14, and the release liner 16. As shown in FIG. 2, the layer comprising the thermally curable pressure-sensitive adhesive 14 is in contact with substantially all one planar surface of the polymeric membrane 12.

In some embodiments, the thermally curable pressure-sensitive adhesive may be positioned between two release liners.

The polymeric membranes used in the multilayer composites of the present invention may be prepared by conventional techniques and commercially available. For example, EPDM membranes useful in the instant multilayer composite include those available from companies such as Carlisle, Johns Manville or Firestone Building Products, and which are offered under a variety of tradenames.

### Characteristics of the Multilayer Composite

According to various embodiments described herein, the layer of crosslinked pressure-sensitive adhesive disposed on a surface of the membrane according to the present invention may be characterized by an advantageous peel strength. Specifically, when adhered to a stainless steel panel, the multilayer composite has a peel strength of at least 6 psi as determined by the method described in PSTC 101.

In one or more embodiments, the layer of crosslinked pressure-sensitive adhesive disposed on a surface of the membrane according to the present invention may be characterized by performance characteristics equivalent if not better than those of UV cured coatings at medium coating thickness, and significantly increased uniformity at high coating thickness.

In one or more embodiments, the layer of crosslinked pressure-sensitive adhesive may be disposed on an article, such as a transfer tape, a heat insulation patch, a sealing tape, an air barrier or underlayment.

### Application to a Roof Surface

The multilayer composite described above may be applied to a substrate, such as nonwoven polypropylene, nonwoven polyethylene, nonwoven polyethylene terephthalate, woven polypropylene, woven polyethylene, spunbond polypropylene, spunbond polyester, and combinations thereof, example. When applied to a substrate, the multilayer composites of the present invention may be used as an underlayment. The underlayment may, in turn, be applied to a roof surface.

The multilayer composites of the present invention can advantageously be applied to a roof surface (also known as roof substrate) by using standard peel and stick techniques. These techniques are generally known to a person of skill in the art. For example, the multilayer composites can be unrolled on a roof surface and placed into position. The multilayer composites can then subsequently be adhered to the roof surface by using various techniques including the use of rollers and the like to mate the adhesive to the substrate.

It has advantageously been discovered that the pressure-sensitive adhesive layers employed in the membranes of the present invention allow the multilayer composites to be adhered to a variety of roofing surfaces. These include, but are not limited to, wood decks, concrete decks, steel decks, faced construction boards, and existing membrane surfaces. In particular embodiments, the membranes of the present invention are adhered, through the cured adhesive layer disclosed herein, to a faced construction board such as, but not limited to, polyisocyanurate insulation boards or cover boards that include facers prepared from polar materials. For example, the adhesives of the present invention provide advantageous adhesion to facers that contain cellulosic materials and/or glass materials. It is believed that the polar nature of the adhesive is highly compatible with the polar nature of these facer materials and/or any adhesives or coatings that may be carried by glass or paper facers. Accordingly, embodiments of the present invention are directed toward a roof deck including a construction board having a cellulosic or glass facer and a membrane secured to the construction board through an at least partially cured polyacrylate adhesive layer in contact with a glass or cellulosic facer of the construction board.

It has advantageously been discovered that the pressure-sensitive adhesive layers employed in the multilayer composites of the present invention allow the multilayer composites to be applied to the roofing surfaces in any temperature window, and at any time installation without exhibiting channeling and tunneling.

According to one embodiment described herein, a method for roofing a structure is provided. The method comprises the following steps:
(a) providing the multilayer composite described above,
(b) removing the release liner from the multilayer composite forming linerless multilayer composite, and
(c) adhering/laminating/installing the linerless multilayer composite onto a roof substructure forming a roof laminate.

The linerless multilayer composite may be installed at a temperature of about −10° C. or greater to about 80° C., or any value encompassed by these endpoints.

### EXAMPLES

The examples demonstrate the advantages and performance characteristics of the present invention.

### Example 1: Comparison of Thermal- and UV-Curing

Four formulations (1-4) comprising differing amounts of acResin® A 250 UV (a hot-melt adhesive available from BASF) and Joncryl ADR 4385 (a liquid polymer chain extender also from BASF) were prepared as hot melt mixed at 130-140 C. The molten adhesive was coated onto a paper release liner at 5 mil. The formulations were subjected to different curing conditions, as shown in Table 1 below. The cured adhesive was transferred onto 2 mil PET for testing.

Six PSA formulations (5-10) comprising differing amounts of acResin® A 250 UV (a hot-melt adhesive available from BASF) and Joncryl ADR 4385 (a liquid polymer chain extender also from BASF) were prepared as hot melt mixed at 130-140 C. The molten adhesive was coated onto a paper release liner at 1, 2, and 3 mil. The formulations were subjected to different curing conditions, as shown in Table 2 below. The cured adhesive was transferred onto 2 mil PET for testing.

The PSA samples were evaluated using the following test methods: Peel strength testing according to PSTC (Pressure Sensitive Tape Council) 101 and PSTC #17 Shear Adhesive Failure Temperature (SAFT) using 1×1×1 kg, 30 min dwell time and 0.5 C/min heating rate. Loop Tack PSTC #16 and Static Shear PSTC #107 (which are tested in one square inch area) were measured for formulations (5-10). The compositions of examples 5 to 10 and of the comparative examples were secured to a stainless-steel panel, the results of these evaluations are summarized in Table 2.

TABLE 1

| Formulation # | 1 | 2 | 3 | 4 |
|---|---|---|---|---|
| A 250 UV (%) | 97.5 | 97.5 | 100.0 | 100.0 |
| Joncryl ADR 4385 (%) | 2.5 | 2.5 | 0.0 | 0.0 |
| A250 UV gm | 146.25 | 146.25 | 150.00 | 150.00 |
| Joncryl ADR 4385 gm | 3.75 | 3.75 | 0.00 | 0.00 |
| Coat thickness (mil) | 5 | 5 | 5 | 5 |
| Cure condition | No cure | 160° C., | No cure | UV-C, 125 |
| | | 10 min | | mJ/cm² |
| SS Peel (lbf) | 3.44656 | 8.57687 | 2.44948 | 9.92696 |
| 30 min dwell | 3.28821 | 8.44941 | 2.67198 | 9.93052 |
| | 3.28181 | 8.48799 | 2.67507 | 10.19279 |
| Average | 3.34 | 8.50 | 2.60 | 10.02 |
| Predominate failure | CF | CF | CF | CF |
| SAFT (deg. F.) | 77.1 | 179.2 | 76.7 | 169.4 |
| 1″ × 1″ × 1 kg | 77.2 | 164.1 | 76.8 | 172 |
| | 77.9 | — | 76.3 | 171.5 |
| Average | 77.40 | 171.65 | 76.60 | 170.97 |

TABLE 2

| | Formulation # | | | | | |
|---|---|---|---|---|---|---|
| | 5 | 6 | 7 | 8 | 9 | 10 |
| A 250 UV (%) | 97.5% | 97.5% | 97.5% | 100.0% | 100.0% | 100.0% |
| Joncryl ADR 4385 | 2.5% | 2.5% | 2.5% | 0.0% | 0.0% | 0.0% |
| (%) | | | | | | |
| Coating Thickness | 1 | 2 | 3 | 1 | 2 | 3 |
| (mil) | | | | | | |
| Curing condition | 160 C., | 160 C., | 160 C., | — | — | — |
| | 10 min | 10 min | 10 min | | | |
| UV-C Dose, | — | — | — | 50 | 50 | 50 |
| mJ/cm2 | | | | | | |
| SS 180 Peel (lbf) | 5.815 | 6.388 | 8.108 | 6.446 | 7.777 | 8.168 |
| 30 min dwell | 6.072 | 6.501 | 8.083 | 5.929 | 7.800 | 8.564 |
| | 5.921 | 6.341 | 7.986 | 6.290 | 7.707 | 8.553 |
| Average | 5.940 | 6.410 | 8.060 | 6.220 | 7.760 | 8.430 |
| Failure Mode | AT | AT | AT | AF | AT | AT |
| SS Loop Tack (lbf) | 5.252 | 9.531 | 10.746 | 4.234 | 8.936 | 12.103 |
| | 5.024 | 9.632 | 9.735 | 4.724 | 9.183 | 12.552 |
| | 4.180 | 8.614 | 12.446 | 4.973 | 10.380 | 13.746 |
| Average | 4.820 | 9.260 | 10.980 | 4.640 | 9.500 | 12.800 |
| Failure Mode | G | G | G | AF | AF | AF |
| SS Static Shear | 1465 | 1890 | 584 | 2431 | 1903 | 1484 |
| (min) | | | | | | |
| 30 min dwell | 810 | 1394 | 3307 | 2871 | 1565 | 770 |
| | 2636 | 1196 | 3471 | 3030 | 822 | 1483 |
| Average | 1637 | 1493 | 2454 | 2777 | 1430 | 1246 |
| Failure Mode | CF | CF | CF | CF | CF | CF |
| SAFT (degrees F.) | 194 | 189 | 205 | 209 | 178 | 167 |
| 1″ × 1″ × 1 kg | 180 | 185 | 191 | 200 | 210 | 163 |
| 30 min dwell | 193 | 182 | 201 | 208 | 177 | 156 |
| Average | 189 | 185 | 199 | 206 | 188 | 162 |
| Failure Mode | CF | CF | CF | CF | CF | CF |

The data demonstrate the usefulness of the present invention. The data shows that thermally cured membranes perform as well as UV cured membranes. This is important because thermally cured hot-melt adhesive compositions overcome the known drawbacks of UV cured compositions (such as limited thickness) without diminishing performance of the final product.

### Example 2: Determination of Exotherm by Differential Scanning Calorimetry (DSC)

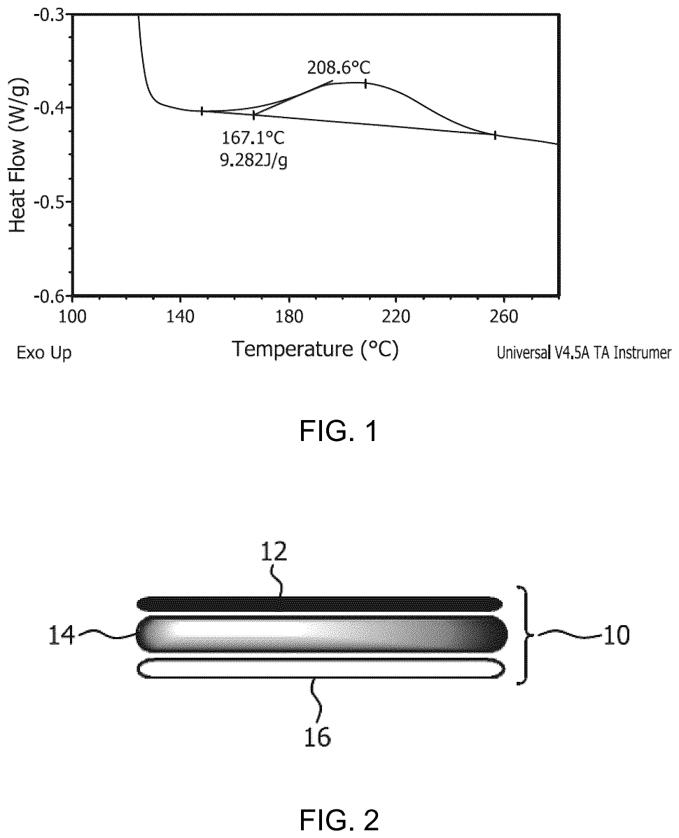

Samples of a formulation comprising Jonacryl ADR 4385 at 5% loading acResin A 250 UV were prepared. The samples were heated to 120° C. and mixed at about 5% loading by weight. The two-part material was then tested on a TA Q200 differential scanning calorimeter. The samples were equilibrated at 120° C. for 1 minute under nitrogen, followed by a temperature increase from 120° C. to 340° C. at a rate of 15° C. per minute. The results are shown in FIG. 1.

For samples (5-7) Joncryl ADR 4385 at 2.5% loading with acResin A 250 UV was prepared. Samples (8-10) only cured at (50 mJ/cm²) UV-C dose. The samples were mixed and coated at around 120° C. For samples (5-7) they are thermally cured at 160° C. for 10 min.

### Example 3: Effect of Tackifying Resin on Peel Adhesion and Shear Adhesive Failure Temperature

The non tackified formulation 1 in Table 3 is hot melt mixed of acResin A250 99% and Joncryl 4395 1%. It was hot melt coated onto a 2 mil PET release liner at 7.5 mil coat weight and thermal cured in the oven at 160° C. for 15 minutes. The adhesive was then laminated onto EPDM roofing membrane. Testing for peel and SAFT were done following PSTC Test Method. Formulation 3 in Table 3 is a blend of acResin A250 94% and Foral 85 5% and Joncryl 4385 1%. It was hot melt mixed with Foral 85 to be uniformly mixed prior to the addition of the Joncryl 4385 crosslinker. Again, the formulation was coated onto 2 mil PET release liner and oven cured at 160 C for 15 minutes. The adhesive was then laminated onto EPDM roofing membrane. In the comparative examples are shown by formulations 2 and 4 in Table 3 which have no Joncryl 4385. Curing was done by UV-C irradiation at 100 mJ/cm2.

TABLE 3

| Sample ID | 1 | 2 | 3 | 4 |
|---|---|---|---|---|
| Product | A250 | A250 | A250 + 5% | A250 + 5% |
| | | | Foral 85 | Foral 85 |
| Substrate | EPDM | EPDM | EPDM | EPDM |
| Cure Type | Thermal | UV | Thermal | UV |
| Thickness (mil) | 7.50 | 7.50 | 7.50 | 7.50 |
| Cure | 15 min | 100 mJ/cm² | 15 min | 100 mJ/cm² |
| Direct / Transfer | | | | |
| Coating | Transfer | Direct | Transfer | Direct |
| Room Temp (73 F.) | 6.78642 | 8.9401 | 12.94618 | 5.27448 |
| SS 180º Peel (pli) | 6.19579 | 9.57477 | 13.18927 | 5.60741 |
| 30 min dwell | | 10.1965 | | 5.03127 |
| | 6.49 | 9.57 | 13.07 | 5.30 |
| Mode of Failure | AT/CF | | | |
| | Stripes | CF | CF | CF |
| SAFT (Temp F) | 136.6 | 99.2 | 159.0 | 78.3 |
| 1″ × 1″ × 1 kg | 149.7 | 101.2 | 164.9 | 78.4 |
| | 169.6 | | 160.7 | |
| | 151.97 | 100.20 | 161.53 | 78.35 |
| Mode of Failure | CF | CF | CF | CF |

Mode of Failure: AF - Adhesive Failure; CF - Cohesive Failure; AT - Adhesive Transfer

It is known in the art that adding a tackifying resin to pressure sensitive polymers, such as acrylic, butyl, natural rubber, SBR, and Styrene Block Copolymer, increases peel adhesion at the expense of reduced cohesive strength (Shear Adhesive Failure Time or Shear Adhesive Failure Temperature). The experimental results in Table 3 show unexpectedly and surprisingly that in thermal cured acrylic hot melt PSA having high molecular weight acrylic polymer with small amount of epoxide containing acrylic oligomer, the addition of small amounts of a tackifying resin (for example, Floral 85) into the composition enhances the peel adhesion without losing the cohesive strength (see formulations 1 and 3 in Table 3)

Various modifications and alterations that do not depart from the scope and spirit of this invention will become apparent to those skilled in the art. This invention is not to be duly limited to the illustrative embodiments set forth herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The term “substantially all of” means an amount or area coverage of 80% or more and is merely intended to serve as a shorthand method of referring individually to each separate value falling within the range from 80% to 100%.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A composition comprising:
an acrylic copolymer based on a polymerization of a monomer A, a monomer B, and a monomer C in an amount from 90% to 99.5% by weight;
a tackifier; and
a crosslinker in an amount of from 0.5 wt. % to 10 wt. %, based on total weight of the composition.

2. The composition of claim 1, wherein monomer A is selected from the group consisting of methyl, ethyl, propyl, isoamyl, isooctyl, n-butyl, isobutyl, tert-butyl, cyclohexyl, 2-ethylhexyl, decyl, lauryl or stearyl acrylate and/or methacrylate, and mixtures thereof.

3. The composition of claim 1, wherein monomer B is selected from the group consisting of acrylic acid, methacrylic acid, itaconic acid, crotonic acid, fumaric acid, maleic acid, maleic anhydride, n-butylmaleic monoesters, monoethyl fumarate, monomethyl itaconate and monomethyl maleate, acrylamide and methacrylamide, N-methyl acrylamide and -methacrylamide, N-methylolacrylamide and-methacrylamide, maleic acid monoamide and diamide, itaconic acid monoamide and diamide, fumaric acid monoamide and diamide, vinylsulfonic acid or vinylphosphonic acid, and mixtures thereof.

4. The composition of claim 1, wherein monomer C is selected methyl acrylate, methyl methacrylate, ethyl methacrylate, n-butyl methacrylate, tert-butyl methacrylate, tert-butyl acrylate, isobutyl methacrylate, vinyl acetate, hydroxyethyl acrylate, hydroxyethyl methacrylate, cyclohexyl acrylate, cyclohexyl methacrylate, 2-ethoxyethyl methacrylate, 2-phenoxyethyl methacrylate, benzyl acrylate, benzyl methacrylate, hydroxypropyl methacrylate, styrene, 4-acetostyrene, acrylamide, acrylonitrile, 4-bromostyrene, n-tert-butylacrylamide, 4-tert-butylstyrene, 2,4-dimethylstyrene, 2,5-dimethylstyrene, 3,5-dimethylstyrene, isobornyl acrylate, isobornyl methacrylate, 4-methoxystyrene, methylstyrene, alpha methylstyrene, 4-methylstyrene, 3-methylstyrene, 2,4,6-trimethylstyrene, vinyl pyrrolidone, ureido methacrylate, and combinations thereof.

5. The composition of claim 1, wherein monomer A is selected from the group consisting of 2-ethylhexyl acrylate, butyl acrylate, and isooctyl acrylate, in an amount of from 50% by weight to 99.99% by weight based on the weight of the monomers A, B and C in the copolymer.

6. The composition of claim 1, wherein monomer B is selected from the group consisting of acrylic acid, methacrylic acid, and itaconic acid, in an amount of from 0.1% by weight to 10% by weight based on the weight of the monomers A, B and C in the copolymer.

7. The composition of claim 1, wherein monomer C is selected from the group consisting of methyl acrylate, methyl methacrylate, vinyl pyrrolidone, ureido methacrylate, styrene, and alpha methylstyrene in an amount of from 0.1% by weight to 25% by weight based on the weight of the monomers A, B and C in the copolymer.

8. The composition of claim 1, wherein the crosslinker comprises an acrylate, a polyfunctional acrylate, a metal salt, a silane coupling agents, a polyfunctional isocyanate, a polyfunctional amine, or polyfunctional alcohol.

9. The composition of claim 1, wherein the crosslinker comprises a glycidyl copolymer.

10. The composition of claim 1, wherein the crosslinker has a glass transition temperature Tg of from about 0 to about −60° C., a weight average molecular weight of from 2 to 40,000 Da, a viscosity from about 1 to about 10,000 P at 25° C., and a functionality per chain of greater than 1 to about 10.

11. The composition of claim 1, wherein the tackifier comprises a natural resin.

12. The composition of claim 11, wherein the natural resin comprises a rosin, a rosin derivative, polyterpene resins, terpene-phenolic resins, alkylphenol resins, and aliphatic, aromatic and aliphatic-aromatic hydrocarbon resins, and combinations thereof.

13. The composition of claim 11, wherein the natural resin comprises an ester of hydrogenated gum rosin.

14. The composition of claim 1, wherein the composition does not include a solvent.

15. A multilayer composite comprising:
a substrate;
a layer comprising the composition of claim 1; and, optionally,
a release liner.

16. The multilayer composite of claim 15, wherein the layer comprising the composition is present in a thickness of from 25 to 500 μm.

17. The multilayer composite of claim 15, wherein the layer comprising the composition is present in a thickness of 5 microns to 150 microns.

18. The multilayer composite of claim 15, wherein the layer comprising the composition is in contact with substantially all of one planar surface of the polymeric membrane.

19. The multilayer composite of claim 15, wherein the multilayer composite has a peel strength, when adhered to a stainless steel panel and tested according to PSTC 101, of at least 6 lbs per inch.

20. The multilayer composite of claim 15, wherein the multilayer composite is a roofing membrane.

21. An underlayment, comprising a substrate and the composition of claim 1.

22. The underlayment of claim 20, further comprising a release liner.

23. The underlayment of claim 20, wherein the substrate is selected from the group consisting of nonwoven polypropylene, nonwoven polyethylene, nonwoven polyethylene terephthalate, woven polypropylene, woven polyethylene, spunbond polypropylene, spunbond polyester, and combinations thereof.

24. A roof assembly comprising the underlayment of claim 20.

25. A process for forming a multilayer composite, the process comprising:
(a) polymerizing a mixture comprising a monomer A, a monomer B, and a monomer C, in an amount of from 90% to 99.5% by weight,
and a crosslinker in an amount from 0.5% to 10% by weight, based on total weight of the acrylic polymer, to provide a thermally curable pressure-sensitive adhesive,
(b) adding a tackifier;
(c) heating the thermally curable pressure-sensitive adhesive,
(d) extruding the adhesive to a planar surface of a polymeric membrane such that adhesive is in contact with substantially all of one planar surface of the polymeric membrane, forming an adhesive coating layer comprising the adhesive;
wherein the adhesive coating layer has a thickness of from 25 to 500 μm,
(e) subjecting the adhesive coating layer to thermal energy;
(f) optionally, cooling the adhesive coating layer;
(g) applying a release liner to the adhesive coating layer to form a multilayer composite; and
(h) winding the composite.

26. The process of claim 25, wherein subjecting the coating to thermal energy comprises subjecting the adhesive coating layer to a temperature from 100° C. to 200° C. for a duration of from 5 min to 15 min.

27. A method for roofing a structure comprising
(a) providing the multilayer composite of claim 15,
(b) removing the release liner from the multilayer composite forming linerless multilayer composite, and
(c) adhering/laminating/installing the linerless multilayer composite onto a roof substructure forming a roof laminate.

28. The method of claim 27, wherein the linerless multilayer composite is installed at a temperature of from about −10° C. to about 80° C.

29. The composition of claim 9, wherein the glycidyl copolymer comprises a glycidyl ether or a glycidyl amine.

30. The composition of claim 1, wherein the crosslinker comprises a carbodiimide, an oxazoline, a peroxide, an azo, a cumene, a glycidyl amine, an adipic acid dihydrazide (ADDH), organometallic compounds, cyanoacrylate compounds, compounds including 1,3-diketo groups, an epoxidized soybean oil, an aziridine, a polyimine, or a polyamine.
